(19) United States
(12) Patent Application Publication
(10) Pub. No.: US 2010/0126074 A1
(43) Pub. Date: May 27, 2010

(54) MULTI-USE HATCH COVER FOR DUCTS HAVING A CURVED CIRCUMFERENCE

(76) Inventor: Stephen S. Martin, Huntington Station, NY (US)

Correspondence Address: Barry G Magidoff, Esq., Paul J. Sutton, Esq.;Sutton Magidoff LLP, 909 Third Avenue - 27 FL, New York, NY, 10022, US

(21) Appl. No.: 12/623,560

(22) Filed: Nov. 23, 2009

Related U.S. Application Data
(60) Provisional application No. 61/118,005, filed on Nov. 26, 2008.

(51) Int. Cl. E05F 11/00; E06B 7/16

(52) U.S. Cl. 49/324; 49/475.1

(57) ABSTRACT

This invention provides a hatch cover suitable for use with fluid ducts having a wide range of diameters, the hatch cover is formed from a plate of a resilient material and is generally of an elongated shape. The resilient material forming the plate has sufficient elasticity to be able to conform to the curvature of the inner surface of a fluid duct when the cover is in place and is held against the inner surface to cover an opening through the duct wall. A flexible gasket material is secured to at least the entire circumferential edge portion of the outer major surface of the resilient plate. The resilient plate is secured to the duct by a plurality of clamping mechanisms attached to the outer surface of the resilient plate so as to press on the outer surface of the duct when clamped, and thus to cause the outer surface of the hatch cover to press against the inner surface of the duct. The gasket material on the outer surface of the plate assists in forming a relatively fluid tight seal between the gasket material and the inner surface of the duct and the outer surface of the resilient plate. The material forming the resilient plate should have sufficient flexibility and elasticity to conform to the curvature of the inner surface of the duct when clamped.

This application claims the benefit of priority pursuant to 35 U.S.C. 119(e) from a U.S. provisional patent application having Application No. 61/118,005 filed Nov. 26, 2008.

### FIELD OF THE INVENTION

This application is directed to a new and improved hatch cover for air ducts, or other fluid conduits, including ducts having flat sides (e.g., having a substantially quadrilateral cross section) as well as ducts having a curved surface, i.e., ducts having a circular or ovoid cross section, or a combination of flat and curved sides.

### SUMMARY OF THE INVENTION

This improved hatch cover allows a single cover to be used on ducts, especially curved ducts, having a relatively broad range of cross-section diameters. The hatch cover comprises a sheet or plate formed of a material having some elasticity, such as spring steel or polypropylene; adhered to the outer major side of the cover is a relatively soft gasket material extending at least around the outer circumferential edge of the outer surface of the sheet or plate, and a plurality of holding devices secured to the outer surface of the sheet or plate and located to designed to sealably secure the hatch cover to the outer circumferential edge of the duct opening by pressing the elastic sheet and soft gasket material against the internal surface of the duct wall around the full circumference of an opening through the duct wall. Preferably, a handle is secured to the outer surface intermediate the holding devices, to support the door while securing it at the opening through the duct wall or removing it therefrom when opening the hatch.

The holding devices each comprises a clamping mechanism, such as a spring-loaded gripping finger resiliently secured at one end to the resilient sheet and movable between a position where it presses against the outer surface adjacent the circumferential edge of the sheet or plate and a position where it is held away from the edges of the sheets; so that when the hatch cover is in place to close off the duct opening, the gripping fingers can be placed so as to press against the outer surface of the duct, and thus act to press the inner surface of the duct against substantially the entire circumferential edge of hatch cover, by causing the resilient sheet to bend to conform to any curvature of the duct wall. The gripping fingers are preferably rotatably movably attached to the resilient sheet. Preferably there are at least three (3) such holding devices, most preferably four (4), equally spaced around the circumference of the plate, and where the plate is circular or ovoidal, the locking devices are located along the major and minor axes.

The elastic sheet or plate is sufficiently resilient so that when the, e.g., gripping fingers are pressing against the outer duct wall, at the edge of the duct opening, the resilient sheet will conform to the curvature of the air duct, and will compress the soft gasket material between the outer surface of the hatch cover and the internal surface of the duct. This allows the use of a single size hatch cover for a wide range of duct diameters, and a range of opening sizes. It is understood that the planar size of the elastic steel plate forming the hatch cover must vary to accommodate all openings, but the hatch cover need not match each variation in opening size. For example, an arm-hole size opening will require a different hatch cover from a man-hole hatch cover for very large ducts. The soft sheet layer, which acts as a sealant gasket along the area of contact between the door and the interior surface of the air duct, can be, for example, a resilient closed cell foam or a resilient rubber pad, such as Neoprene gasket material. The pad can be secured only over a small portion of the surface of the resilient sheet, i.e., so that it extends completely around the outer circumference of the hatch cover, or can cover the entire surface. The soft material is used to seal the contacts with the duct wall conforming more closely to any unevenness in the surfaces of the duct walls.

In either case, it is intended to form a substantially airtight seal with the inner surface of the air duct around the access opening. It is understood that because of the nature of the seams found in the great majority of air ducts, the extent of the airtight seal with respect to its ability to prevent any loss of pressure is relatively low, because of the low pressure drop maintained in such air ducts. However, the advantage of the hatch cover of the present invention is that the sealing provided is generally of a sufficiently high quality to be useful in air ducts which are intended to maintain greater than the usual pressure differential than what is generally used in the heating, ventilation and air conditioning of most inhabited structures.

### BRIEF DESCRIPTION OF THE DRAWINGS

FIG. 1 is a top plan view drawing of the hatch cover of the present invention;

FIG. 2 is a cutaway partial side view drawing of the hatch cover of the present invention taken along lines A-A of FIG. 1; and

FIG. 3 is a cutaway partial side view drawing of the hatch cover of the present invention taken along lines B-B of FIG. 1.

### DESCRIPTION OF THE PREFERRED EMBODIMENT OF THE INVENTION

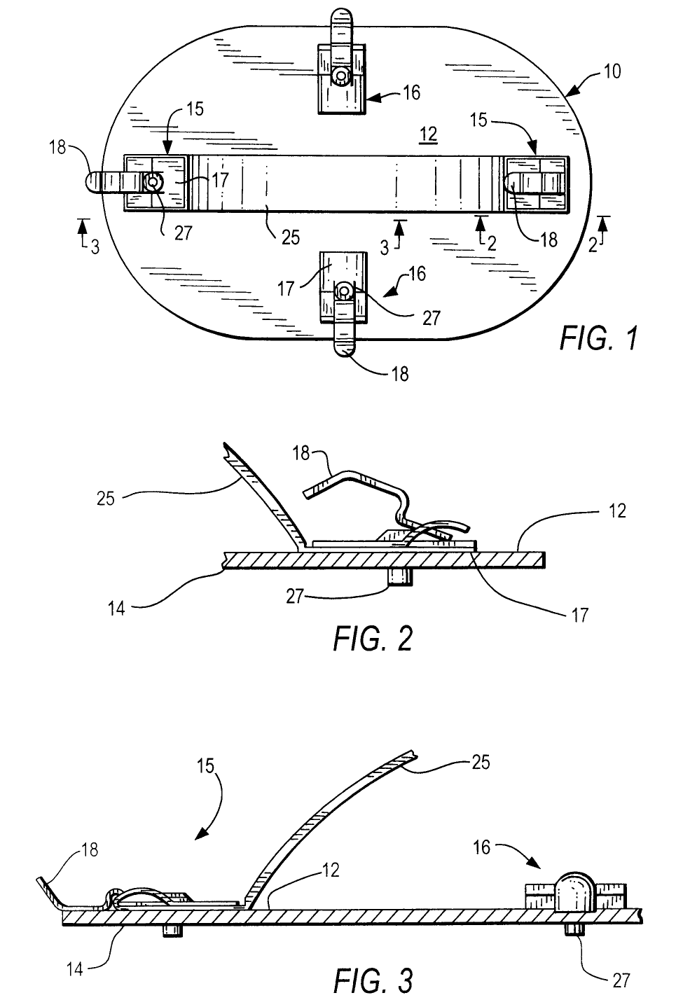

Referring now to the drawings as shown in FIGS. 1-3, the hatch cover is shown generally in FIG. 1 as numeral 10. In this preferred embodiment, the hatch cover comprises an ovoidal spring steel (or hardened carbon steel) sheet 14, the entire outer surface of which is covered by a gasket sheet 12, in this example, a closed cell neoprene gasket material. Four snap fastener clamping mechanisms 15, 16 are secured to the spring steel sheet 14 by rivets 27, which extend through the gasket sheet and support plate 14, at four diametrically opposite points adjacent to the circumferential edge of the hatch cover 10. The clamping mechanisms 15,16 each comprise a resilient gripping finger 18 held in place by a clip plate 17, which is in turn secured to the hatch cover 10 by, e.g., the rivets 27. The pair of clamping mechanisms 16 is secured adjacent opposite ends of the short diameter i.e. minor diameter, of the ovoidal hatch cover 10, and the clamping mechanisms 15 are secured adjacent opposite ends of the long diameter, i.e. major diameter, of the ovoidal hatch cover 10. The clip plates 17 are each partially split into three sections, a central finger 18 which is directly secured to the support plate by rivet 27 and the outer forks 22. The gripping finger 18, in the closed position presses against the outer surface of the duct wall so as to press the door gasket 12 against the inner surface of the duct wall.

A handle 25 is preferably secured to the outer surface of the hatch cover 10, to allow for easy handling of the cover when closing or opening the hatch.

In the closed position, as is shown in FIG. 3, when the hatch cover is placed inside of the air duct, by pulling on the handle the hatch cover is caused to press against the internal surface of the air duct wall such that the external circumference of the neoprene sheet presses against the internal surface of the duct wall, and forms a relatively airtight seal. The gripping fingers 18 of each of the clamps 15, 16 press down on the outer surface of the air duct wall, as shown in FIG. 3, pressing the two pieces, i.e. the wall of the air duct and the hatch cover together such that the inner surface of the duct is pressed against the outer surface of the hatch cover. The gasket material 12, which may be, for example, closed cell foam neoprene sheet, forms a seal against the inner surface of the duct, when the resilient hatch cover is caused to bend to match the contour of the duct wall. The clamping effect is released by raising the gripping fingers 18 to the open position shown in FIG. 2, releasing the hatch cover, allowing its removal, to open the hatch and allow access to the interior of the duct for any repair or maintenance purposes desired. Generally these access openings are merely for purposes of reaching in with the arm or hand of the worker. However the hatch cover can be sufficiently large to in effect act as a manhole cover for a sufficiently large access opening in a very large air duct.

This system can also be applicable to other fluid piping means including for example pipes carrying water or other liquids. In such cases, a greater number of clamps may be required to maintain a secure seal if there is a high flow rate in the duct.

Alternative embodiments, which can be used without changing the nature of this invention, which is specifically directed to the use of the resilient sheet or plate, are screw down clamps to hold the hatch cover and duct opening edges together, or other known or to be developed alternatives for causing two surfaces to be clamped and a sufficient pressure to form a desired seal and cause the resilient bending of the hatch cover plate.

The resilient nature of the plate forming the hatch cover can be achieved using so-called spring steel which may be a high carbon steel or a stainless steel or even a plastic material, i.e., a synthetic polymer, such as a polypropylene plate, if such is desirable. Indeed, a flexible piece of wood, e.g. plywood, or a so-called “engineered wood” such medium density or high density fiberboard, can also be useful in this situation although the physical characteristics of wood or fiberboard are not adequate for long time service in this regard.

The general structure of these doors can be inexpensively manufactured through techniques well known to the plastic and/or metal working arts. Resilient plates can be formed by a variety of known processes which do not form an aspect of the present invention.

In addition to the separate neoprene sheet described above, a sealant layer can be applied prior to polymerization, so as to form the surface gasket sheet in situ and thus form a suitable adhesive seal between the gasket surface material and the resilient plate.

While the preferred embodiments of the invention have been described, modifications can be made in addition to those specifically referred to and other embodiments may be devised without departing from the spirit of the invention and the scope of the appended claims.

The following invention is claimed:

1. A hatch cover suitable for use with fluid ducts having a wide range of diameters, the hatch cover comprising a resilient plate having an outer major surface and an inner major surface and an elongated shape, the resilient plate being formed of a resilient material having sufficient elasticity to be able to conform to any curvature of the inner surface of a fluid duct when the cover is held against the inner surface and covering an opening through the inner surface of the duct; flexible gasket material secured to at least the entire circumferential edge portion of the outer major surface of the resilient plate, and a plurality of clamping mechanisms secured to the outer major surface of the resilient plate so as to grip the outer surface of the duct and when clamped to cause the hatch cover to press against the inner surface of the duct against the gasket material so as to form a relatively fluid tight seal between the gasket material and the inner surface, the resilient plate having sufficient flexibility and elasticity to conform to the curvature of the inner surface of the duct.

2. The hatch cover of claim 1 further comprising a handle secured to the outer major surface of the resilient plate.

3. The hatch cover of claim 2 wherein the gasket material is secured to and covers the entire outer major surface of the resilient plate, and where the clamping mechanisms and the handle are secured to the plate through the gasket material.

4. The hatch cover of claim 1 wherein the elongated plate has a substantially ovoidal shape, and wherein there are four clamping mechanisms located along the major and minor axes of the ovoidal hatch cover plate.

5. The hatch cover of claim 1 wherein the resilient plate is formed of high carbon steel and the gasket material is a closed cell neoprene foam.
